(19) United States
(12) Patent Application Publication
(10) Pub. No.: US 2012/0198619 A1
(43) Pub. Date: Aug. 9, 2012

(54) Accessory For Beds

(76) Inventor: Jorge Juan Garcia Garcia, Granada (ES)

(21) Appl. No.: 13/023,732

(22) Filed: Feb. 9, 2011

(51) Int. Cl. A47C 21/00; F21V 33/00; A47C 31/00

(52) U.S. Cl. 5/503.1; 362/130

(57) ABSTRACT

Accessory for beds, characterised by the inclusion of an articulated support, anchored to the bed head that presents an axis of rotation which is approximately vertical with respect to the bed head, and operatively capable of lateral displacement of the telescopic arm and which is associated to a primary telescopic arm by means of a folding action, at the free end of this primary telescopic arm is a secondary laterally revolving, arm carrying folding support rods, which allow its arrangement in an approximate upright position to hold a book or similar, an approximate horizontal position, which enables the support of a tray or similar and a position of withdrawal on the revolving arm for its complete withdrawal on the telescopic arm next to the bed head. It includes a reading lam which is joined to the articulated support by means of a flexible neck.

### THE OBJECT OF THE INVENTION

The present invention refers to an accessory for a bed which enables the stable support of diverse objects such as reading books or service trays.

### HISTORY OF THE INVENTION

At the present time various types of accessories exist to bring objects closer to a person lying or sitting in a bed. For example, small auxiliary tables exist that include a horizontal top from which legs, in the form of a “C”, extend to the floor and end in wheels so that the small table can be brought closer to the bed, laterally, leaving the top over the bed and in front of the person seated or lying in the bed.

However, these tables present a problem of storage when they are not in use, as they occupy a considerable amount of space.

In addition, these tables do not allow the positioning of a book or magazine in a comfortable reading position, that is to say, in an approximately vertical or slightly inclined position, according to the position of the reader in the bed.

### DESCRIPTION OF THE INVENTION

The bed accessory, the object of this invention, is intended to allow its suitable use as a support for reading books or trays and similar items, occupies a minimum amount of space and is easily removed when not in use and is easily concealed.

The accessory includes an articulated support anchored to the bed head and is linked to a primary telescopic arm in a folding manner. At the free end of this primary telescopic arm there is a secondary, laterally revolving, arm which carries folding support rods, and which can acquire an approximate upright position, an approximate horizontal position or be folded when not in use, on the revolving arm. Thus, the rods can hold a book in their upright position, leaving the book at an optimal reading angle, and by means of inclination the rods become approximately horizontal, defining a support following a horizontal plane, on which a service tray or similar can be deposited.

This accessory can be easily tidied away by means of the collapse of its arms, leaving it in a vertical position next to the bed head in a minimum of space. The telescopic arm and the transverse, rod carrying arm, allow the positioning of objects with total freedom in front of a person sitting or lying in the bed for their greater comfort.

The articulated support presents an axis of rotation approximately vertical with respect to the bed head. This axis of rotation allows the lateral displacement of the telescopic arm, moving it away from the bed. In addition, when the accessory is tidied away it does not protrude from the bed head, but remains arranged laterally.

An option has been anticipated by which the accessory includes a reading lamp, which is preferably fixed to the articulated support by means of a flexible neck for its most suitable positioning on the part of the user.

### DESCRIPTION OF THE FIGURES

In order to complement the description that is made and with the object of facilitating the understanding of the characteristics of the invention, a set of drawings accompanies the present descriptive statement in which, with an illustrative and non-limiting character, the following are represented:

FIG. 1 shows a perspective view of a bed with the accessory unfolded in the position to hold a tray.

FIG. 2 shows a perspective view of a bed with the accessory unfolded in the position to hold a book.

FIG. 3 shows a perspective view of a bed with the accessory tidied away in the out of use position on the bed head.

FIG. 4 shows a plan view of a bed with the accessory unfolded in the position to hold a tray.

FIG. 5 shows a plan view of a bed with the accessory unfolded in the position to hold a book.

FIG. 6 shows a plan view of the accessory folded in the out of use position on the bed head.

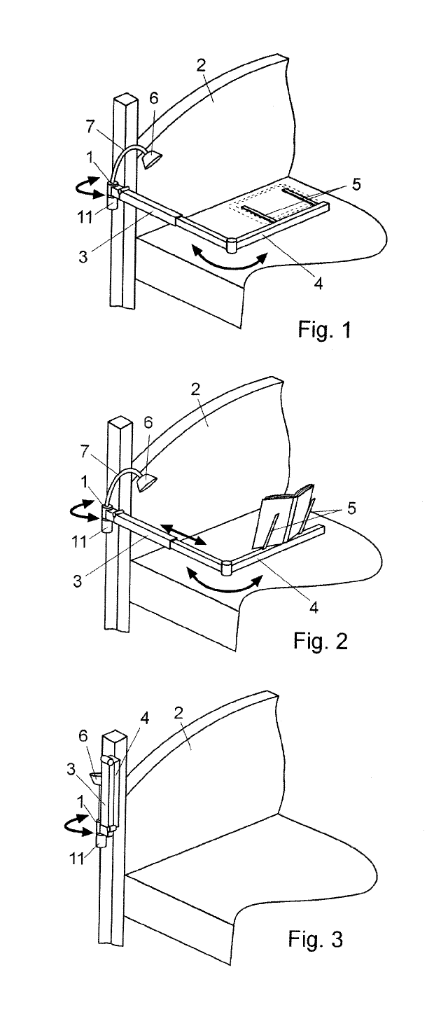

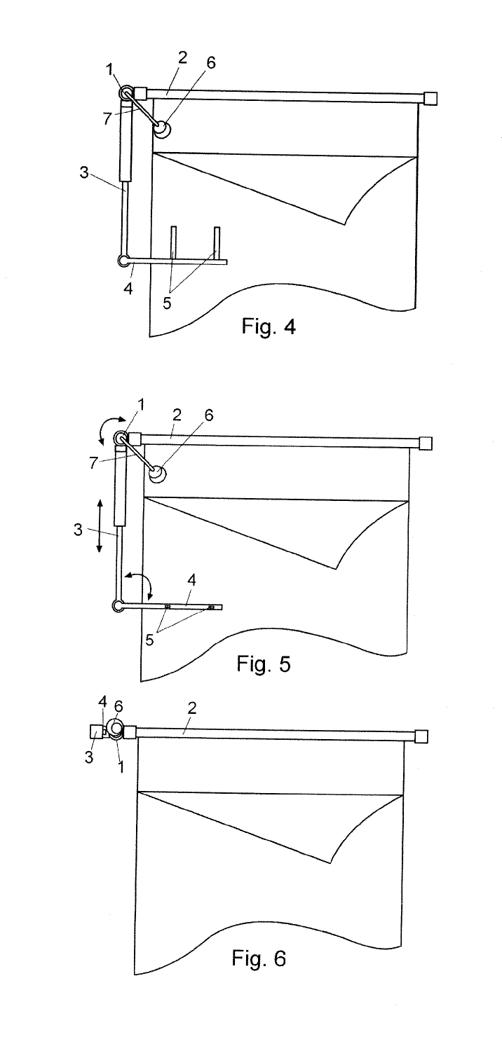

### PREFERRED ACCOMPLISHMENT OF THE INVENTION

As can be observed in the reference diagrams, the bed accessory includes an articulated support (1) anchored to the side of the bed head (2), a primary folding telescopic arm (3) from this support (1) and a secondary laterally revolving arm (4) at the free end of the telescopic arm (3). This revolving arm (4) presents two folding rods (5), which can be arranged approximately parallel in a vertically upright position, lowered horizontally or stowed away on the revolving arm (4) when not in use.

The articulated support (1) presents an axis of rotation (11), approximately vertical with respect to the bed head (2), that enables the lateral displacement of the telescopic arm (3) and the storage of the accessory when not in use to one side of the bed head (2).

In a preferred option the accessory includes a reading lamp (6) with a flexible neck (7) positioned and anchored on the articulated support (1).

With the nature of the invention sufficiently described, together with an example of its preferred accomplishment, the opportune effects of how the materials, form, size and arrangement of the described elements could be modified are indicated, as long as it does not suppose an alteration of the essential characteristics of the invention as are claimed as follows.

1. A bed accessory, characterised by the inclusion of an articulated support (1), anchored to the bed head (2) and which is associated to a primary telescopic arm (3) by means of a folding action, at the free end of this primary telescopic arm (3) is a secondary, laterally revolving, arm (4) carrying folding support rods (5), which allow its arrangement in an approximate upright position to hold a book or similar, an approximate horizontal position, which enables the support of a tray or similar and a position of withdrawal on the revolving arm (4) for its complete withdrawal on the telescopic arm (3) next to the bed head (2).

2. The accessory, according to claim 1, characterised by the articulated support (1) presenting an axis of rotation (11) which is approximately vertical with respect to the bed head (2), and operatively capable of lateral displacement of the telescopic arm (4).

3. The accessory, according to claim 1, characterised by the inclusion of a reading lamp (6).

4. The accessory, according to claim 4, characterised by the reading lamp (6) joined to the articulated support (1) by means of a flexible neck (7).
